(19) United States
(12) Patent Application Publication
(10) Pub. No.: US 2018/0334267 A1
(43) Pub. Date: Nov. 22, 2018

(54) AIRCRAFT ENGINE STAND CRADLE PULLEY SYSTEM

(71) Applicant: Westmont Industries, Santa Fe Springs, CA (US)

(72) Inventors: Cassandra R. Bailey, Los Angeles, CA (US); Payam Habibi Hosseinabadi, Laguna Nigel, CA (US)

(73) Assignee: Westmont Industries, Santa Fe Springs, CA (US)

(21) Appl. No.: 15/599,373

(22) Filed: May 18, 2017

(51) Int. Cl. B64F 5/50; F16M 3/00; F16M 11/24; F16M 11/42

(52) U.S. Cl. CPC B64F 5/50; F16M 11/42; F16M 11/24; F16M 3/00

(57) ABSTRACT

An improved aircraft engine stand is disclosed, which comprises a cradle assembly comprising a cable pulley system for controlling a vertical height of the cradle assembly with respect to a base assembly, and one or more cam follower rollers configured to engage with the base assembly for smooth vertical translation of the cradle assembly with respect to the base assembly.

### BACKGROUND OF THE INVENTION

The present invention relates generally to an improved aircraft engine stand.

Aircraft engine stands generally aspire to accommodate aircraft engines of different sizes and configurations. For example, an aircraft engine stand can be configured to receive an engine with or without a fan. An aircraft engine fan adds significant volume and height to the aircraft engine. As such, when an aircraft engine includes a fan, the aircraft engine stand must provide sufficient clearance to accommodate the fan's height. In order to accommodate engines having different sizes and configurations, aircraft engine stands may be adjustable in height.

In existing aircraft engine stands, adjustments in height may be performed by translating a cradle assembly relative to a base assembly, e.g., by moving the cradle assembly vertically with respect to the base assembly. Therefore, an engine mounted on a cradle assembly imposes significant lateral loads on the base assembly. The base assembly provides the stationary ground for the cable loads. These lateral loads may cause deformations in the base assembly. Such deformations may impede the ability of the cradle assembly to be moved vertically relative to the base assembly.

It can readily be appreciated that there is a need for an improved aircraft engine stand that allows for vertical displacement of an aircraft engine installed on the aircraft engine stand. Furthermore, there is a need for an aircraft engine stand that addresses the problems posed by the large loads transferred to the aircraft engine stand by the mounted aircraft engine. The present invention fulfills these needs and provides further related advantages.

### SUMMARY OF THE INVENTION

The present invention may be embodied in an a cradle assembly for mounting an aircraft engine, which comprises a cable pulley system for controlling a vertical height of the cradle assembly with respect to a base assembly, and one or more cam follower rollers configured to engage with the base assembly for smooth vertical translation of the cradle assembly with respect to the base assembly.

In one aspect, the one or more cam follower rollers mitigate one or more effects of lateral loads placed on the base assembly by an aircraft engine mounted on the cradle assembly.

In another aspect, the one or more cam follower rollers transfer at least a portion of the lateral loads placed on the base assembly by an aircraft engine mounted on the cradle assembly to the base assembly.

In a preferred embodiment, the one or more cam follower rollers are configured to engage one or more vertical guide bars of the base assembly.

In a further aspect of this embodiment, each of the one or more cam follower rollers is configured to engage a respective one of the one or more vertical guide bars of the base assembly.

In a preferred embodiment, the cable pulley system comprises: a hydraulic cylinder, and a hydraulic pump to lengthen and collapse the hydraulic cylinder. In one aspect of this embodiment, changes to the length of the hydraulic cylinder cause the cradle assembly to translate vertically with respect to the base assembly.

In another aspect of this embodiment, the cable pulley system further comprises a plurality of cables secured to the hydraulic cylinder. Changes to the length of the hydraulic cylinder cause changes to the length of a first portion of each cable of the plurality of cables, and the changes to the length of the first portion of each cable of the plurality of cables causes the cradle assembly to translate vertically with respect to the base assembly. In one aspect of this embodiment, an end of each cable of the plurality of cables is secured to a first end of the hydraulic cylinder.

In yet another aspect of this embodiment, extension of the hydraulic cylinder to a maximum length corresponds to a maximum vertical position of the cradle assembly, and collapsing of the hydraulic cylinder to a minimum length corresponds to a minimum vertical position of the cradle assembly.

In one embodiment, the cradle assembly can further comprise a first opening configured to align with one or more openings on the base assembly for insertion of a pin to secure the cradle assembly at one or more vertical positions associated with the one or more openings.

The present invention may also be embodied in an aircraft engine stand comprising a base assembly and the cradle assembly described above.

In a preferred embodiment, the aircraft engine stand further comprises one or more shock mounts positioned between the cradle assembly and the base assembly.

These and other features and advantages of the invention should become more readily apparent from the detailed description of the preferred embodiments set forth below taken in conjunction with the accompanying drawings, which illustrate, by way of example, the principles of the invention. It should be appreciated that many other features, applications, embodiments, and/or variations of the disclosed technology will be apparent from the accompanying drawings and from the following detailed description. Additional and/or alternative implementations of the structures, systems, and methods described herein can be employed without departing from the principles of the disclosed technology.

### BRIEF DESCRIPTION OF THE DRAWINGS

Embodiments of the present disclosure will now be described, by way of example only, with reference to the following drawings.

FIG. 1 provides a perspective view of an aircraft engine stand including a cradle assembly and a base assembly, in accordance with an embodiment of the present invention.

FIG. 2 provides a top-down cross-sectional view of the aircraft engine stand of FIG. 1.

FIG. 3 provides a cross-sectional view of the aircraft engine stand of FIG. 2 along line A-A.

FIG. 4 provides a cross-sectional view of the aircraft engine stand of FIG. 2 along line B-B.

FIG. 5 provides a close-up, top-down view of a cam follower roller on a cradle assembly engaged with a vertical guide bar, in accordance with an embodiment of the present invention.

FIG. 6 provides a front plan view of a cam follower roller engaged with a vertical guide bar, in accordance with an embodiment of the present invention.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DESCRIPTION OF THE INVENTION

The present invention provides an improved aircraft engine stand which allows for effective vertical displacement of an aircraft engine mounted on the aircraft engine stand, among other related advantages.

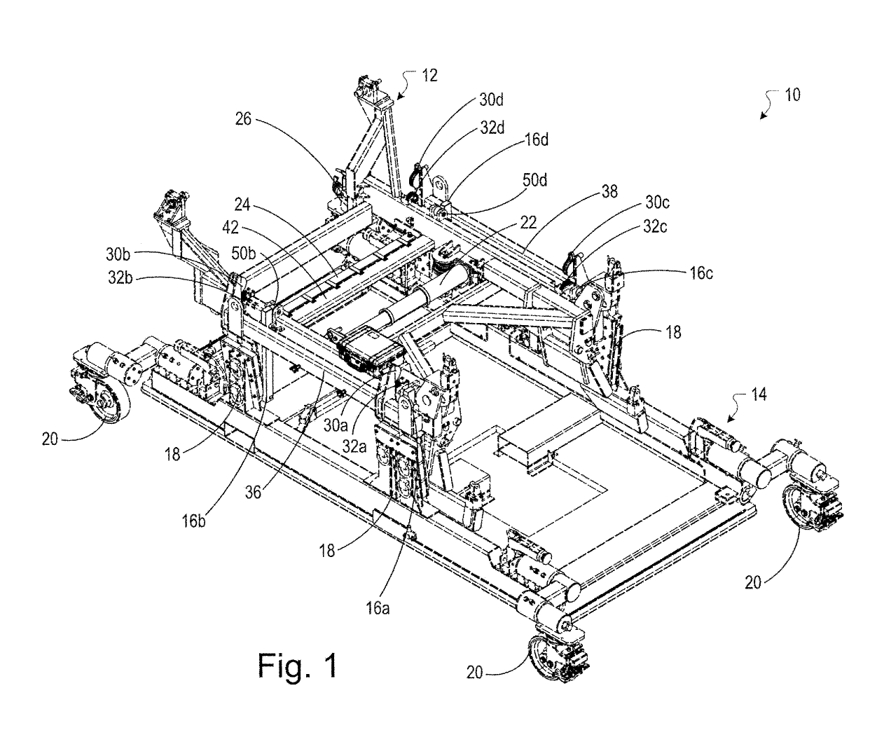

Referring now to the drawings, and particularly to FIG. 1 thereof, there is shown a perspective view of an aircraft engine stand 10, in accordance with an exemplary embodiment of the present invention. The aircraft engine stand 10 includes a cradle assembly 12 and a base assembly 14. The cradle assembly 12 is configured to receive and support an aircraft engine. The base assembly 14 is configured to receive and support the cradle assembly 12. The base assembly 14 can also be configured to allow for transport of the cradle assembly 12 with or without an engine. In the example embodiment depicted, the base assembly 14 includes caster assemblies 20 on each corner for moving the aircraft engine stand 10.

The base assembly 14 includes four vertical guide bars 16a-d. The four vertical guide bars 16-d guide the cradle assembly 12 as the cradle assembly 12 is raised or lowered vertically with respect to the base assembly 14. Proximate the four vertical guide bars 16a-d are shock mounts 18, which provide a level of shock dampening and/or isolation between the cradle assembly 12 and the base assembly 14.

As mentioned above, the cradle assembly 12 can be moved vertically with respect to the base assembly 14. The cradle assembly 12 includes a cable pulley system that can be used to adjust the vertical position of the cradle assembly 12. In the exemplary embodiment shown in FIG. 1, the cradle assembly 12 includes a hydraulic cable pulley system including a telescoping hydraulic cylinder 22, a hydraulic fluid tank 24, and a hydraulic pump 26. The hydraulic fluid tank 26 is filled with hydraulic fluid. The hydraulic pump 26 can be utilized to pump hydraulic fluid from the hydraulic fluid tank 26 into or out of the telescoping hydraulic cylinder 22. In certain embodiments, the hydraulic pump 26 allows for manual adjustment of the vertical position of the cradle assembly 12, with or without an engine mounted. When hydraulic fluid is pumped into the telescoping hydraulic cylinder 22, the cylinder 22 expands. Conversely, when hydraulic fluid is removed and/or pumped out of the telescoping hydraulic cylinder 22, the cylinder 22 collapses or contracts.

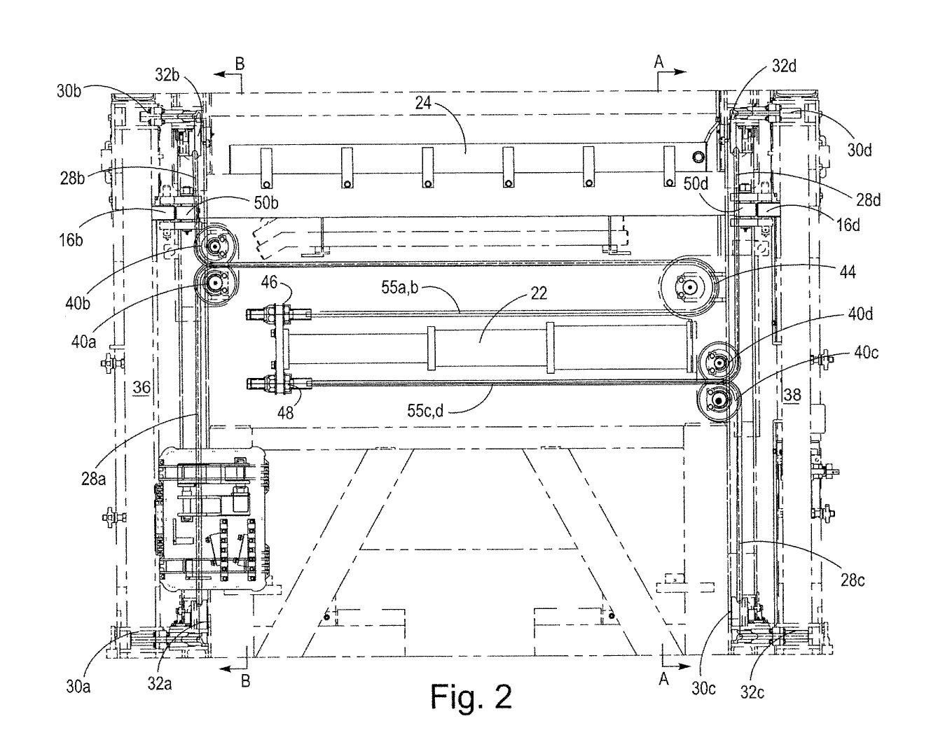

Expansion and contraction of the telescoping hydraulic cylinder causes the cradle assembly 12 to translate vertically with respect to the base assembly 14. In the example embodiment shown, vertical movement of the cradle assembly 12 is effectuated using four cables that are connected to the telescoping hydraulic cylinder 22. The cable pulley system, and the arrangement of the four cables, will be described in greater detail with further reference to FIGS. 2-4.

FIG. 2 provides a top-down cross-sectional view of the aircraft engine stand 10 to more clearly illustrate the configuration of the cable pulley system. A first cable 28a extends from a half pulley 30a positioned at a front right-hand corner of the cable support beam 36. The first cable 28a extends downward from the half pulley 30a, around a vertical pulley 32a positioned below the half pulley 30a, and into cradle 12 (shown in FIG. 1). The first cable 28a then wraps around a horizontal pulley 40a positioned within a cradle cross beam 42 (shown in FIG. 1), around another horizontal pulley 44, and then terminates at an aft, left-hand corner 46 of the telescoping hydraulic cylinder 22.

A second cable 28b extends downward from a half pulley 30b positioned at an aft right-hand corner of the cable support beam 36. The second cable 28b wraps around a vertical pulley 32b, into the cradle assembly 12, around a horizontal pulley 40b (housed within the cradle cross beam 42), around the horizontal pulley 44, and terminates at the same aft, left-hand corner 46 of the telescoping hydraulic cylinder 22 as the first cable 28a.

A third cable 28c extends downward from a half pulley 30c positioned at a front left-hand corner of the cable support beam 38. The third cable 28c wraps around a vertical pulley 32c, into the cradle assembly 12 (shown in FIG. 1), around a horizontal pulley 40c, and terminates at a front, left-hand corner 48 of the telescoping hydraulic cylinder 22. A fourth cable 28d extends downward from a half pulley 30d positioned at an aft left-hand corner of the cable support beam 38, wraps around a vertical pulley 32d, into the left-hand cradle assembly 12, around a horizontal pulley 40d, and terminates at the same front, left-hand corner 48 of the telescoping hydraulic cylinder 22 as the third cable 28c.

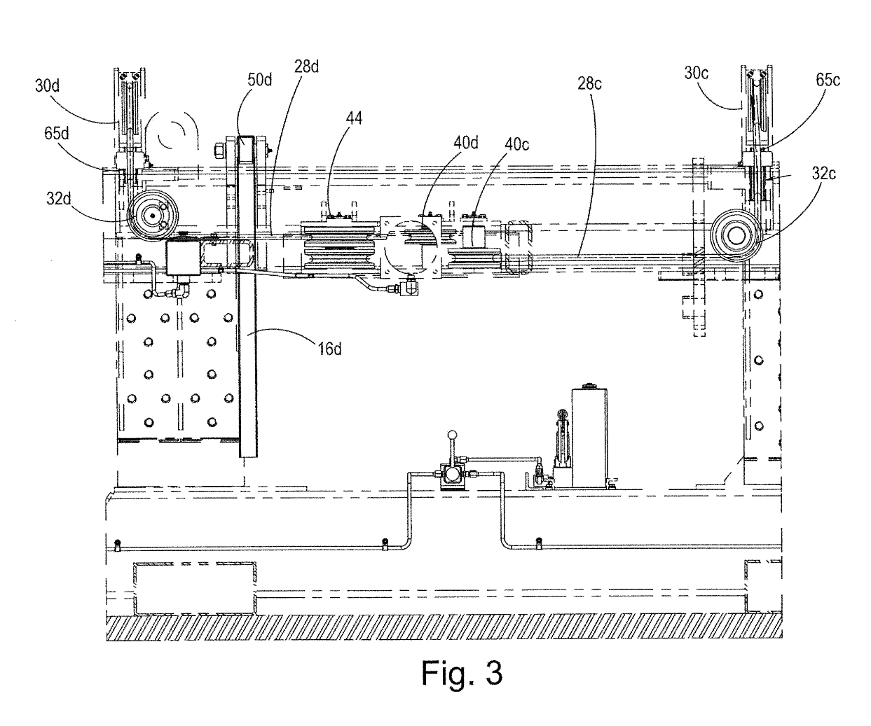

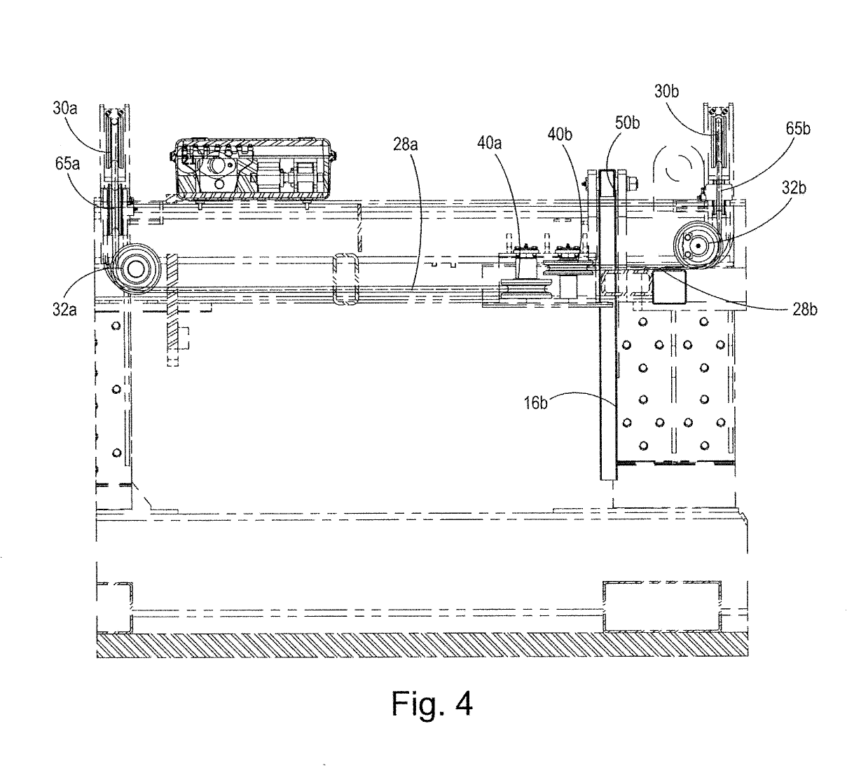

It can be seen in FIG. 2, that each of the cables 28a-d terminate at a left-hand end of the telescoping hydraulic cylinder 22. As such, as the telescoping hydraulic cylinder 22 extends and collapses, the length of a terminal portion 55a-d of the four cables 28a-d changes accordingly. In FIG. 2, the telescoping hydraulic cylinder 22 is fully extended. As such, the terminal portions 55a-d are at their maximum length. If the telescoping hydraulic cylinder 22 collapses, the length of the terminal portions 55a-d will shorten. Each of the cables 28a-d is of a fixed length. As such, shortening of the terminal portions 55a-d will cause other portions of the cables 28a-d to lengthen. As will be shown and described in greater detail in FIGS. 3 and 4, collapsing of the telescoping hydraulic cylinder 22, and resultant shortening of the terminal portions 55a-d of the cables 28a-d, cause the opposing terminal portions of the cables 28a-d to lengthen, which causes the cradle assembly 12 to lower. The opposite is also true: expansion of the telescoping hydraulic cylinder 22, and resultant lengthening of the terminal portions 55a-d of the cables 28a-d, cause the opposing terminal portions of the cables 28a-d to shorten, which causes the cradle assembly 12 to translate upward to a higher vertical position.

FIG. 3 provides a cross-sectional view of the aircraft engine stand 10 of FIG. 2 taken along the line A-A. In FIG. 3, cables 28c and 28d can be seen. Cable 28c terminates at a half pulley 30c, and extends downward from the half pulley 30c to a vertical pulley 32c. Between the half pulley 30c and the vertical pulley 32c, cable 28c has a vertical terminal portion 65c. As discussed above, when the telescoping hydraulic cylinder 22 extends, an opposing terminal portion 55c (shown in FIG. 2) lengthens. As a result, the vertical terminal portion 65c shortens. The shortening of the vertical terminal portion 65c causes one corner of the cradle assembly 12 to be raised vertically, i.e., to translate upward. Accordingly, when the telescoping hydraulic cylinder 22 contracts, the opposing terminal portions 55c shortens, the vertical terminal portion 65c lengthens, and a corner of the cradle assembly 12 is lowered, i.e., translates downward. The cable 28d can be described in the same way. The cable 28d terminates at a half pulley 30d, and extends downward to a vertical pulley 32d. Between the half pulley 30d and the vertical pulley 32d is a terminal vertical portion 65d. When the telescoping hydraulic cylinder 22 extends, the cable 28d is pulled, and the terminal vertical portion 65d shortens, causing one corner of the cradle assembly 12 to rise. When the telescoping hydraulic cylinder 22 collapses, the cable 28d is given more slack, causing the terminal vertical portion 65d to lengthen, and one corner of the cable assembly 12 to be lowered.

FIG. 4 provides a cross-sectional view of the aircraft engine stand 10 shown in FIG. 2 taken along the line B-B. FIG. 4 shows that the cables 28a and 28b also terminate in terminal vertical portions 65a, 65b, which can be shortened or lengthened as the telescoping hydraulic cylinder 22 extends or collapses, respectively. Since the telescoping hydraulic cylinder 22 is connected to all four cables 28a-d, extending and collapsing the hydraulic cylinder 22 causes all four corners of the cradle assembly 12 (and, therefore, the cradle assembly itself) to translate upward and downward, respectively.

Returning to FIG. 1, termination of cables 28a-d (at half pulleys 30a-d) (shown in FIG. 2) are structurally connected to the base assembly 14. So loads applied to the cradle assembly 12 translate through the cables 28a-d to the cable terminations 30a-d and support beams 36 and 38. The cradle assembly 12 includes four cam follower rollers 50a-d. Each of the cam follower rollers 50a-d engages a respective one of the four vertical guide bars 16a-d to assist in smooth vertical translation of the cradle assembly 12 with respect to the base assembly 14. When an engine is mounted on the cradle assembly 12, significant lateral loads are translated through the cables 28a-d to the base assembly 14. As a result of these lateral loads, the base assembly 14 may have a tendency to either collapse inwards towards its center, or extend outwards. Such lateral loads and resultant deformations in the base assembly 14 can cause the cradle assembly 12 to potentially rub against the vertical guide bars 16a-d. Such tension could prevent the cradle assembly 12 from moving smoothly up and down the vertical guide bars, and sufficiently high force or tension could prevent vertical movement completely. The cam follower rollers 50a-d allow the cradle assembly 12 to move vertically along the vertical guide bars 16a-d smoothly with minimal friction or tension. A bearing of the cam follower rollers 50a-d can comprise a plastic or rubber material, or any other suitable materials.

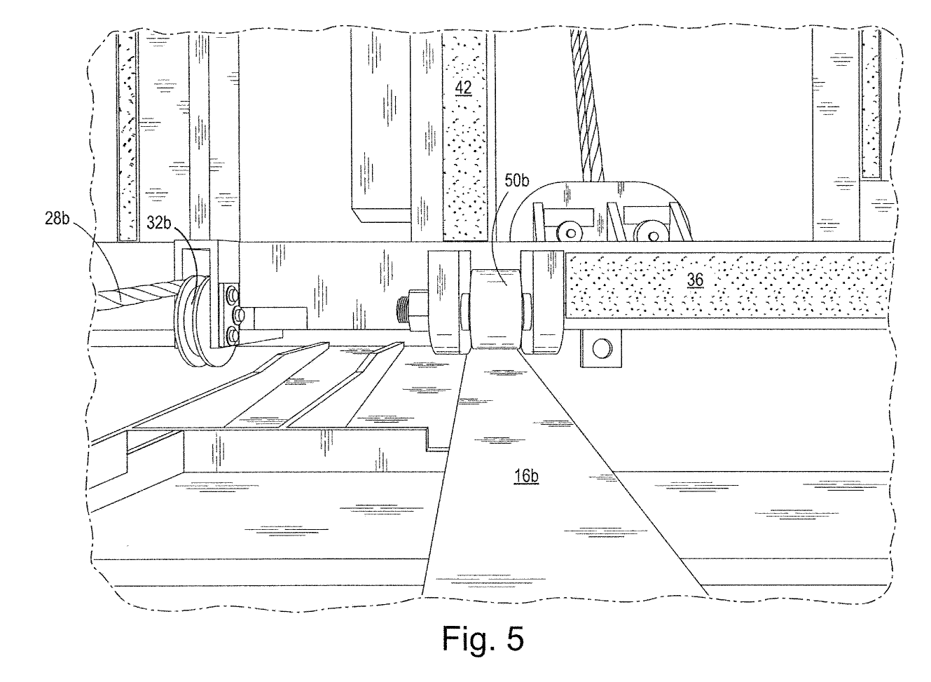

FIG. 5 provides a close-up, top-down view of a cam follower roller 50b engaged with a vertical guide bar 16b. This close-up view more clearly demonstrates how the cam follower roller 50b allows for smooth vertical movement of the cradle assembly 12 up and down the vertical guide bar 16b.

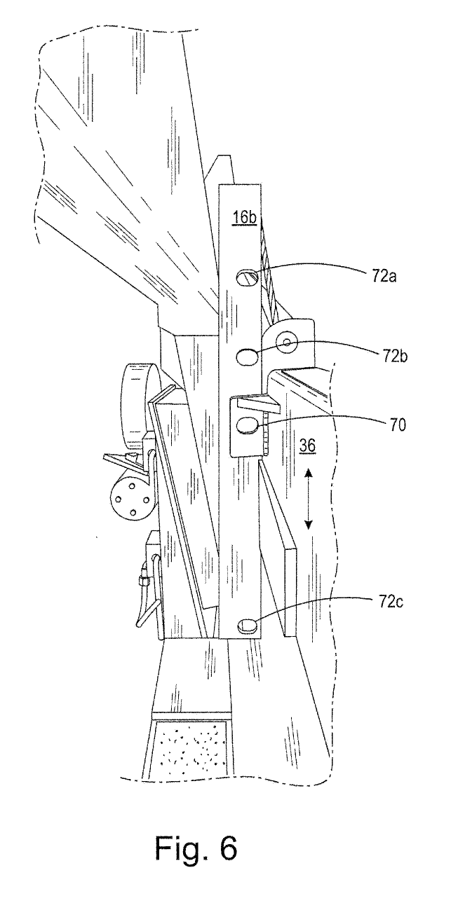

FIG. 6 provides a front plan view of the vertical guide bar 16b. From this perspective, it can be seen that the vertical guide bar 16b includes three openings 72a, 72b, and 72c at various heights along the vertical guide bar 16b. The cradle assembly 12 also has an opening 70 that extends from the right-hand cable support beam 36. As the cradle assembly 12 is moved vertically, the opening 70 of the cradle assembly 12 can be lined up with one of the openings 72a-c on the vertical guide bar 16b. The cradle assembly 12 can be secured into one of three heights associated with the openings 72a-c by placing a pin through both the opening 70 and one of the openings 72a-c. For example, the cradle assembly 12 can be secured into a lowest height setting by lining up the opening 70 with the lowest opening 72c, and placing a pin through both openings. The cradle assembly 12 can be secured into a middle height setting by lining up the opening 70 with the middle opening 72b, and placing a pin through both openings. The cradle assembly 12 can be secured into a highest height setting by lining up the opening 70 with the highest opening 72a, and placing a pin through both openings. In certain embodiments, each of the vertical guide bars 16a-d can include openings at the same heights as the openings 72a-c. In this way, each vertical guide bar can receive a pin to secure the cradle assembly 12 at one of the three heights that correspond to the openings 72a-c. It should be appreciated that any combination of the vertical guide bars 16a-d can be equipped with one or more openings to secure the cradle assembly 12 at various heights. For example, all four vertical guide bars 16a-d, or a subset of the vertical guide bars, can have one or more openings at the same heights or at different heights for insertion of pins to secure the cradle assembly 12 at various heights.

Although the invention has been disclosed with reference only to presently preferred embodiments, those of ordinary skill in the art will appreciate that various modifications can be made without departing from the invention. The specification and figures are, accordingly, to be regarded in an illustrative rather than a restrictive sense. As such, the present invention is defined only by the following claims and recited limitations.

1. A cradle assembly for mounting an aircraft engine comprising:
a cable pulley system for controlling a vertical height of the cradle assembly with respect to a base assembly; and
one or more cam follower rollers configured to engage with the base assembly for smooth vertical translation of the cradle assembly with respect to the base assembly.

2. The cradle assembly of claim 1, wherein the one or more cam follower rollers mitigate one or more effects of lateral loads placed on the base assembly by an aircraft engine mounted on the cradle assembly.

3. The cradle assembly of claim 2, wherein the one or more cam follower rollers transfer at least a portion of the lateral loads placed on the base assembly by an aircraft engine mounted on the cradle assembly to the base assembly.

4. The cradle assembly of claim 1, wherein the one or more cam follower rollers are configured to engage one or more vertical guide bars of the base assembly.

5. The cradle assembly of claim 4, wherein each of the one or more cam follower rollers is configured to engage a respective one of the one or more vertical guide bars of the base assembly.

6. The cradle assembly of claim 1, wherein the cable pulley system comprises:
a hydraulic cylinder, and
a hydraulic pump to lengthen and collapse the hydraulic cylinder, wherein
changes to the length of the hydraulic cylinder cause the cradle assembly to translate vertically with respect to the base assembly.

7. The cradle assembly of claim 6, wherein the cable pulley system further comprises:
a plurality of cables secured to the hydraulic cylinder, wherein
changes to the length of the hydraulic cylinder cause changes to the length of a first portion of each cable of the plurality of cables, and
the changes to the length of the first portion of each cable of the plurality of cables causes the cradle assembly to translate vertically with respect to the base assembly.

8. The cradle assembly of claim 6, wherein
extension of the hydraulic cylinder to a maximum length corresponds to a maximum vertical position of the cradle assembly, and
collapsing of the hydraulic cylinder to a minimum length corresponds to a minimum vertical position of the cradle assembly.

9. The cradle assembly of claim 1, further comprising a first opening configured to align with one or more openings on the base assembly for insertion of a pin to secure the cradle assembly at one or more vertical positions associated with the one or more openings.

10. An aircraft engine stand comprising:
a base assembly; and
a cradle assembly configured to be secured to the base assembly and to receive an aircraft engine, the cradle assembly comprising:
a cable pulley system for controlling a vertical height of the cradle assembly with respect to the base assembly; and
one or more cam follower rollers configured to engage with the base assembly for smooth vertical translation of the cradle assembly with respect to the base assembly.

11. The aircraft engine stand of claim 10, wherein the one or more cam follower rollers mitigate one or more effects of lateral loads placed on the base assembly by an aircraft engine mounted on the cradle assembly.

12. The aircraft engine stand of claim 11, wherein the one or more cam follower rollers transfer at least a portion of the lateral loads placed on the base assembly by an aircraft engine mounted on the cradle assembly to the base assembly.

13. The aircraft engine stand of claim 10, wherein the one or more cam follower rollers are configured to engage one or more vertical guide bars of the base assembly.

14. The aircraft engine stand of claim 13, further comprising a first opening configured to align with one or more openings on a first vertical guide bar of the one or more vertical guide bars for insertion of a pin to secure the cradle assembly at one or more vertical positions associated with the one or more openings.

15. The aircraft engine stand of claim 13, wherein each of the one or more cam follower rollers is configured to engage a respective one of the one or more vertical guide bars of the base assembly.

16. The aircraft engine stand of claim 10, wherein the cable pulley system comprises:
a hydraulic cylinder, and
a hydraulic pump to lengthen and collapse the hydraulic cylinder, wherein
changes to the length of the hydraulic cylinder cause the cradle assembly to translate vertically with respect to the base assembly.

17. The aircraft engine stand of claim 16, wherein the cable pulley system further comprises:
a plurality of cables secured to the hydraulic cylinder, wherein
changes to the length of the hydraulic cylinder cause changes to the length of a first portion of each cable of the plurality of cables, and
the changes to the length of the first portion of each cable of the plurality of cables causes the cradle assembly to translate vertically with respect to the base assembly.

18. The aircraft engine stand of claim 17, wherein an end of each cable of the plurality of cables is secured to a first end of the hydraulic cylinder.

19. The aircraft engine stand of claim 16, wherein
extension of the hydraulic cylinder to a maximum length corresponds to a maximum vertical position of the cradle assembly, and
collapsing of the hydraulic cylinder to a minimum length corresponds to a minimum vertical position of the cradle assembly.

20. The aircraft engine stand of claim 10, further comprising one or more shock mounts positioned between the cradle assembly and the base assembly.
